(19) United States
(12) Patent Application Publication
(10) Pub. No.: US 2020/0298880 A1
(43) Pub. Date: Sep. 24, 2020

(54) SELF-DRIVING VEHICLE DRIVING CONTROL SYSTEM AND SELF-DRIVING VEHICLE

(71) Applicant: Toyota Jidosha Kabushiki Kaisha, Toyota-shi Aichi-ken (JP)

(72) Inventors: Nobuhide Kamata, Susono-shi (JP); Yasuo Uehara, Gotemba-shi (JP); Nozomu Hatta, Susono-shi (JP); Shunsuke Tanimori, Susono-shi (JP)

(73) Assignee: Toyota Jidosha Kabushiki Kaisha, Toyota-shi Aichi-Ken (JP)

(21) Appl. No.: 16/821,255

(22) Filed: Mar. 17, 2020

(30) Foreign Application Priority Data
Mar. 19, 2019 (JP) 2019-051378

(51) Int. Cl. B60W 60/00; G05D 1/00; G06K 9/00

(52) U.S. Cl. CPC B60W 60/0011; G05D 1/0022; G05D 2201/0213; G06K 9/00791; G06K 9/00832; B60W 60/0025

(57) ABSTRACT

A self-driving vehicle driving control system and a self-driving vehicle are provided. The system comprises: a self-driving vehicle which is capable of autonomous driving, and which includes a vehicle sensor which acquires first information representing a status of surroundings of the self-driving vehicle, etc.; a first server which generates a first driving instruction based on the first information, and which transmits the generated first driving instruction to the self-driving vehicle; and a second server which acquires second information representing the status of the surroundings of the self-driving vehicle, etc. from an external sensor, the second server generating a second driving instruction based on the second information, and transmitting the generated second driving instruction to the self-driving vehicle; wherein driving of the self-driving vehicle is controlled in accordance with the first or second driving instruction.

### CROSS-REFERENCE TO RELATED APPLICATION

This application claims priority to Japanese Patent Application No. 2019-051378 filed on Mar. 19, 2019, the entire contents of which are herein incorporated by reference.

### FIELD

The present disclosure relates to a self-driving vehicle driving control system and a self-driving vehicle.

### BACKGROUND

In recent years, self-driving vehicles which are capable of autonomous driving without being operated by a human have been developed. Furthermore, services such as ride-sharing services using such self-driving vehicles have been proposed (Patent Literature 1).

When a self-driving vehicle is in a state which cannot be autonomously managed during autonomous driving (e.g., temporary sensor malfunction), rectification of such a state by a human which enters the self-driving vehicle has been considered. However, in this case, a comparatively long time until the recovery of autonomous driving is needed, and thus, such a solution is particularly not preferable for services such as ride-sharing services.

In order to solve such a problem, an unmanned driving system which is capable of driving a self-driving vehicle by remote control based on image information or the like supplied from the self-driving vehicle has been proposed (Patent Literature 2).

Note that regarding the remote control of self-driving vehicles, a vehicle remote control device which enables driving by remote control only when a user is in the vicinity of the vehicle and the vehicle can be monitored when the self-driving vehicle is automatically moved to a preset target location has been proposed (Patent Literature 3).

### CITATION LIST

### Patent Literature

[PTL 1] Japanese Unexamined Patent Publication No. 2017-182137

[PTL 2] Japanese Unexamined Patent Publication No. 2018-063615

[PTL 3] Japanese Unexamined Patent Publication No. 2013-045290

### SUMMARY

### Technical Problem

As described above, the remote control of a self-driving vehicle based on information such as image information supplied from the self-driving vehicle has been proposed. Furthermore, the instruction of conditions related to driving control from a remote location based on information supplied from the self-driving vehicle has been considered.

However, in some cases, the information supplied from the self-driving vehicle is not sufficient for the instruction of conditions related to suitable driving control of the self-driving vehicle.

Thus, a self-driving vehicle driving control system and a self-driving vehicle which can solve such problems is provided.

### Solution to Problem

The aspects of the present disclosure are as described below.

### <Aspect 1>

A self-driving vehicle driving control system, comprising:

a self-driving vehicle which is capable of autonomous driving, and which includes a vehicle sensor which acquires first information representing at least one of a status of surroundings of the self-driving vehicle, a vehicle status of the self-driving vehicle itself, and a vehicle interior status of the self-driving vehicle,

a first server which is provided so as to be capable of communicating with the self-driving vehicle, which generates a first driving instruction for instruction of conditions related to driving control of the self-driving vehicle based on the first information received from the self-driving vehicle, and which transmits the generated first driving instruction to the self-driving vehicle, and

a second server which is provided so as to be capable of communicating with the self-driving vehicle, the second server being provided so as to be capable of communicating with an external sensor different from the vehicle sensor and which acquires second information representing at least one of the status of the surroundings of the self-driving vehicle, the vehicle status of the self-driving vehicle itself, and the vehicle interior status of the self-driving vehicle, the second server generating a second driving instruction for instruction of conditions related to driving control of the self-driving vehicle based on the second information received from the external sensor, and transmitting the generated second driving instruction to the self-driving vehicle, wherein

driving of the self-driving vehicle is controlled in accordance with the first or second driving instruction.

### <Aspect 2>

The system according to Aspect 1, wherein the self-driving vehicle prioritizes the second driving instruction when the self-driving vehicle receives both the first and second driving instructions.

### <Aspect 3>

The system according to Aspect 1 or 2, wherein a type of conditions related to the driving control which can be instructed by the second driving instruction is more limited than the type of conditions related to driving control which can be instructed by the first driving instruction.

### <Aspect 4>

The system according to any one of Aspects 1 to 3, wherein the second server generates the second driving instruction based on the first information received from the self-driving vehicle in addition to the second information received from the external sensor.

### <Aspect 5>

The system according to any one of Aspects 1 to 4, wherein the external sensor is at least one of a sensor attached to a vehicle other than the self-driving vehicle and a sensor attached to a stationary object.

### <Aspect 6>

The system according to any one of Aspects 1 to 5, wherein the external sensor comprises two or more sensors present in positions different from each other.

### <Aspect 7>

A self-driving vehicle which is capable of autonomous driving, comprising:

a vehicle sensor which acquires first information representing at least one of a status of surroundings of the self-driving vehicle, a vehicle status of the self-driving vehicle itself, and a vehicle interior status of the self-driving vehicle,

an external communication interface which is configured so as to be capable of communicating with a first server and a second server, wherein the external communication interface receives, from the first server, a first driving instruction for instruction of conditions related to driving control of the self-driving vehicle generated based on the first information, and receives, from the second server, a second driving instruction for instruction of conditions related to driving control of the self-driving vehicle generated based on second information received from an external sensor different from the vehicle sensor and which acquires the second information indicating at least one of a status of the surroundings of the self-driving vehicle, the vehicle status of the self-driving vehicle itself, and the vehicle interior status of the self-driving vehicle, and

a processor which controls driving of the self-driving vehicle in accordance with the first or second driving instruction.

### <Aspect 8>

The self-driving vehicle according to claim 7, wherein the processor prioritizes the second driving instruction when the external communication interface receives both the first and second driving instructions.

### Advantageous Effects

According to the self-driving vehicle driving control system and self-driving vehicle of the present disclosure, the problem in which, in some cases, the information supplied from the self-driving vehicle is insufficient for the instruction of conditions related to suitable driving control of the self-driving vehicle can be solved.

### BRIEF DESCRIPTION OF DRAWINGS

FIG. 1 is a conceptual view detailing the self-driving vehicle driving control system and self-driving vehicle of the present disclosure.

FIG. 2 is a schematic configuration diagram detailing the configuration of the self-driving vehicle of the present disclosure.

FIG. 3 is a schematic configuration diagram detailing the configuration of a first server used in the self-driving vehicle driving control system of the present disclosure.

FIG. 4 is a schematic configuration diagram detailing the configuration of a second server used in the self-driving vehicle driving control system of the present disclosure.

FIG. 5 is a sequence diagram showing an example of operation of a passenger transportation system.

FIG. 6 is a sequence diagram detailing the self-driving vehicle driving control system of the present disclosure.

FIG. 7 is a flowchart detailing control of the first server used in the self-driving vehicle driving control system of the present disclosure.

FIG. 8 is a flowchart detailing control of the second server used in the self-driving vehicle driving control system of the present disclosure.

FIG. 9 is a flowchart detailing control of the self-driving vehicle of the present disclosure.

### DETAILED DESCRIPTION

The embodiments of the present disclosure will be described below with reference to the drawings.

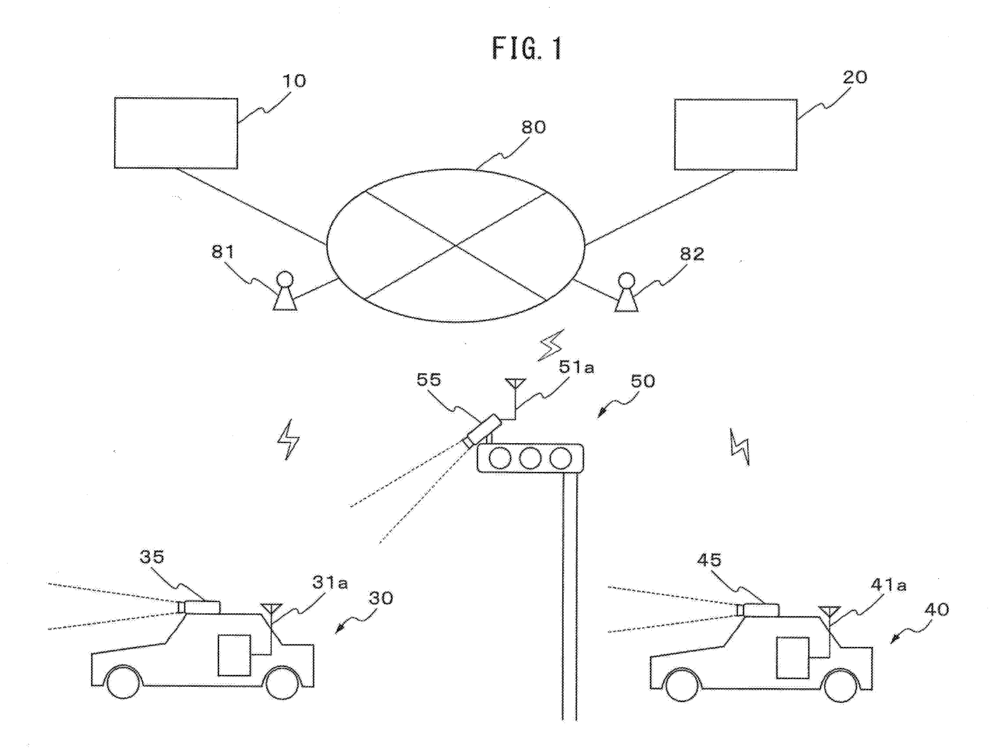

FIG. 1 is a schematic configuration diagram of the self-driving vehicle driving control system according to an embodiment of the present disclosure. The self-driving vehicle driving control system comprises a self-driving vehicle 30, a first server 10, and a second server 20, as shown in FIG. 1.

As described above, conventionally, information supplied from the self-driving vehicle may be insufficient for the instruction of conditions related to suitable driving control in some cases.

Conversely, in the self-driving vehicle driving control system of the present disclosure, the first server instructs conditions related to driving control based on information supplied from the self-driving vehicle, and the second server instructs conditions related to driving control based on information supplied from an external sensor other than the sensors mounted on the self-driving vehicle, whereby the above problems can be solved. The information supplied from the external sensor can be supplied as information which cannot be supplied from the self-driving vehicle, such as, for example, information regarding locations in the blind spots of the sensors mounted on the self-driving vehicle, information regarding locations which cannot be detected by the sensors mounted on the self-driving vehicle due to other vehicles, or information regarding locations which cannot be detected by the sensors mounted on the self-driving vehicle due to separation from the self-driving vehicle.

### (Self-Driving Vehicle)

The self-driving vehicle 30 may be a vehicle which is owned and privately operated by a user, or may be a vehicle which provides mobility services such as car-sharing or ride-sharing services. Specifically, in the case in which the self-driving vehicle 30 is a vehicle providing mobility services, the vehicle transports passengers including the user to a desired destination in accordance with a dispatch request from the user. In ride-sharing services, a plurality of users having destinations which are close to each other can simultaneously utilize a single vehicle 30.

The self-driving vehicle 30 is capable of communicating with the first server 10 and the second server 20 via a communication network 80 constituted by wireless communication base stations 81, 82, and optical communication lines.

The self-driving vehicle 30 is a vehicle which is capable of autonomous driving and which does not require a driver to operate the vehicle.

A self-driving vehicle 30 which is owned and privately operated by the user is autonomously driven based on a driving plan created by at least one of the self-driving vehicle 30 itself, the first server 10, and the second server 20, and transports the user to the destination.

A self-driving vehicle 30 used in mobility services is autonomously driven based on a driving plan created by at least one of the self-driving vehicle 30 itself, the first server 10, and the second server 20, and transports the user to the destination. Furthermore, in mobility services, a plurality of self-driving vehicles 30 are used so that multiple users can utilize the service. The self-driving vehicles 30 are managed by the service provider which provides the mobility services.

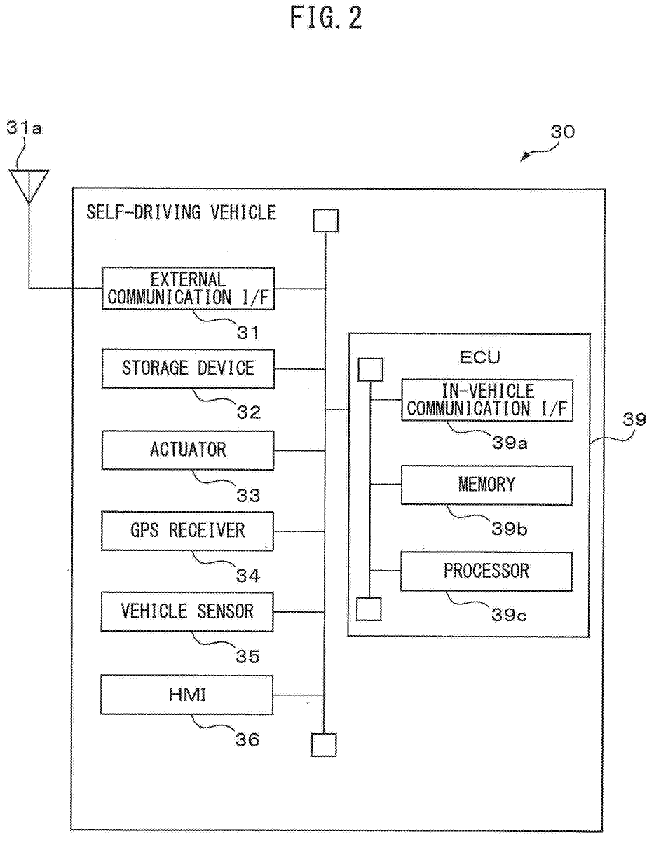

FIG. 2 is a view schematically illustrating the configuration of the self-driving vehicle 30. The self-driving vehicle 30 comprises an electronic control unit (ECU) 39. The ECU 39 comprises an in-vehicle communication interface 39a, a memory 39b, and a processor 39c, and executes the various controls of the self-driving vehicle 30. In particular, the ECU 39 performs vehicle driving control in accordance with the first driving instruction instructing conditions related to driving control of the self-driving vehicle generated by the first server and the second driving instructions instructing conditions related to driving control of the self-driving vehicle generated by the second server. The first and second driving instructions can include instructions related to the destination of the vehicle, the driving route, stops, speed limits, lane management, and the like. The in-vehicle communication interface 39a and the memory 39b are connected to the processor 39c via communication lines. Note that though a single ECU 39 is provided in the present embodiment, a plurality of ECUs may be provided for each function.

The in-vehicle communication interface 39a comprises an interface circuit for connecting the ECU 39 with an in-vehicle network conforming to standards such as CAN (controller area network). The ECU 39 communicates with other vehicle equipment via the in-vehicle communication interface 39a.

The memory 39b includes volatile semiconductor memory (e.g., RAM) and nonvolatile semiconductor memory (e.g., ROM). The memory 39b stores programs executed by the processor 39c and various data used when various processes are executed by the processor 39c.

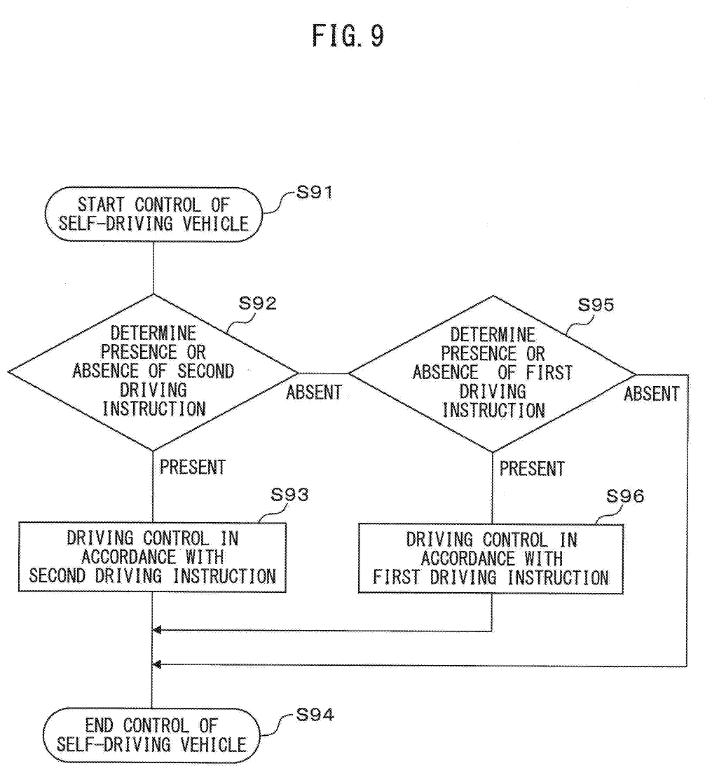

The processor 39c comprises one or a plurality of CPUs (central processing units) and the peripheral circuits therefor, and executes various processes. Note that the processor 39c may further comprise arithmetic circuits such as logical operation units or numerical operation units. The details of the processes performed by the processor are described below in regards to FIG. 9.

The self-driving vehicle 30 comprises an external communication interface 31. The external communication interface 31 is equipment which enables communication between the self-driving vehicle 30 and the outside of the self-driving vehicle 30 via a wireless communication antenna 31a mounted on the vehicle. The external communication interface 31 includes, for example, a data communication module (DCM). The data communication module communicates with the first server 10 and the second server 20 via the wireless communication base stations 81, 82 and the communication network 80.

The self-driving vehicle 30 comprises a storage device 32. The storage device 32 includes, for example, a hard disk drive (HDD), a solid-state drive (SDD), or an optical storage medium. The storage device 32 stores various types of data, such as, for example, user information, vehicle information, map information, and a computer program with which the processor 39c can execute various types of processing. The map information and computer program may be recorded and distributed on a recording medium such as an optical recording medium or a magnetic recording medium. The map information may be updated using data received from outside of the self-driving vehicle 30 or SLAM (Simultaneous Localization and Mapping) technology.

The self-driving vehicle 30 comprises an actuator 33. The actuator 33 operates the self-driving vehicle 30. The actuator 33 is connected to the ECU 39 via the in-vehicle network, and the ECU 39 controls the actuator 33. For example, the actuator 33 includes a drive device (at least one of an engine and a motor) for accelerating the self-driving vehicle 30, a break actuator for decelerating the self-driving vehicle 30, a steering motor for steering the self-driving vehicle 30, a door actuator for opening and closing the doors or controlling the door locks of the self-driving vehicle 30, etc.

The self-driving vehicle 30 comprises a GPS receiver 34. The GPS receiver 34 receives signals from 3 or more GPS satellites, and detects the current position (e.g., the latitude and longitude of the self-driving vehicle 30) of the self-driving vehicle 30. The GPS receiver 34 is connected to the ECU 39 via the in-vehicle network, and the output of the GPS receiver 34 is transmitted to the ECU 39.

The self-driving vehicle 30 comprises a vehicle sensor 35. The vehicle sensor 35 detects at least one of the status of the surroundings of the self-driving vehicle 30, the vehicle status of the self-driving vehicle 30 itself, and the status of the interior of the self-driving vehicle 30 for autonomous driving of the self-driving vehicle 30. The vehicle sensor 35 is connected to the ECU 39 via the in-vehicle network, and the output of the vehicle sensor 35 is transmitted to the ECU 39. Furthermore, the processor 39c of the ECU 39 transmits the first information representing at least one of the status of the surroundings of the self-driving vehicle 30, the vehicle status of the self-driving vehicle 30 itself, and the status of the interior of the self-driving vehicle 30 to the first server via an external communication interface.

The status of the surroundings includes information such as the white lines of the road, other vehicles, pedestrians, bicycles, buildings, signs, traffic lights, and obstacles. For example, the vehicle sensor 35 for acquiring the status of the surroundings, i.e., the surroundings information detection device, includes an external vehicle camera, millimeter wave radar, LIDAR (laser imaging detection and ranging), an ultrasonic sensor, etc. The external vehicle camera generates images by photographing the exterior of the self-driving vehicle 30.

The vehicle status includes information such as the speed of the vehicle and a yaw rate, which is the rotational speed around the vertical axis passing through the center of gravity of the vehicle. For example, the vehicle sensor 35 for acquiring the vehicle status, i.e., the vehicle status detection device, includes a vehicle sensor, a yaw rate sensor, etc.

The vehicle interior status includes information such as the number and characteristics of the passengers riding in the vehicle. For example, the vehicle sensor 35 for acquiring the vehicle status, i.e., the vehicle interior status detection device, detects passengers in the self-driving vehicle 30, and detects the boarding and exit of the passengers. For example, the vehicle interior status detection device includes an interior vehicle camera, seatbelt sensor, seat sensors, etc.

The interior vehicle camera generates an image by photographing the passengers of the self-driving vehicle 30. Specifically, the interior vehicle camera is arranged on, for example, the ceiling or the like of the self-driving vehicle 30 so as to photograph the passengers of the self-driving vehicle 30. Note that the interior vehicle camera may be a plurality of cameras arranged in different locations within the self-driving vehicle 30. Furthermore, the seatbelt sensors detect whether the seatbelts have been used by the passengers. The seat sensors detect whether passengers are seated in the seats. The seatbelt sensors and the seat sensors are provided for each seat.

The self-driving vehicle 30 comprises a human-machine interface (HMI) 36. The HMI 36 is an input/output device with which information can be exchanged between the passengers and the self-driving vehicle 30. The HMI 36 includes, for example, a display for displaying information, a speaker for generating sound, operation buttons or a touch screen with which the passengers can perform input operations, a microphone which receives the voices of the passengers, etc. The HMI 36 provides information (the current location of the self-driving vehicle 30, weather, outside temperature, etc.) and entertainment (music, movies, television shows, games, etc.) to the passengers of the self-driving vehicle 30. The HMI 36 is connected to the ECU 39 via the in-vehicle network, the output of the ECU 39 is transmitted to the passengers via the HMI 36, and the input from the passengers is transmitted to the ECU 39 via the HMI 36.

### (First Server)

The first server 10 is provided so as to be capable of communicating with the self-driving vehicle 30 via a gateway (not illustrated), the communication network 80, and the wireless communication base stations 81, 82. Furthermore, the first server 10 generates the first driving instruction instructing conditions related to driving control of the self-driving vehicle based on the first information, such as the status of the surroundings of the self-driving vehicle, received from the self-driving vehicle, and transmits the generated first driving instruction to the self-driving vehicle.

When the self-driving vehicle 30 is a vehicle owned by the user, the first server 10 manages the self-driving vehicle 30 to efficiently provide automatic driving. Furthermore, when the self-driving vehicle 30 is a vehicle which provides mobility services, the first server 10 manages the user and self-driving vehicle to efficiently provide the mobility services. In this case, in particular, the first server 10 performs registration of user information, matching between the user and the self-driving vehicle 30, creation of the driving plan, and the settlement of usage fees.

The first server 10 is managed by a service provider which services the self-driving vehicle, such as a service provider which provides a service which monitors self-driving vehicles owned by users, or a service provider which provides mobility services.

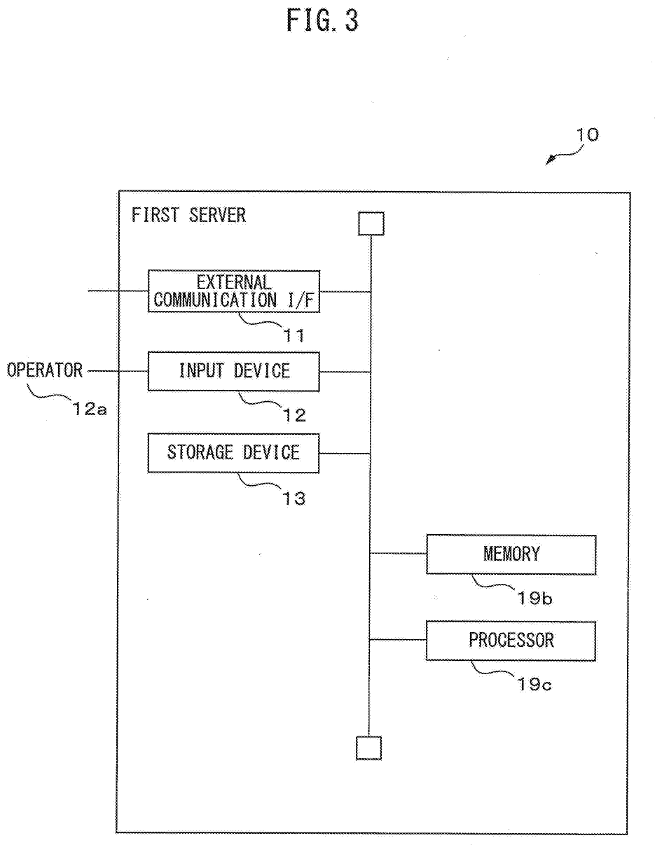

As shown in FIG. 3, the first server 10 comprises an external communication interface 11, an input device 12, a storage device 13, a memory 19b, and a processor 19c. The external communication interface 11, input device 12, storage device 13, and memory 19b are connected to the processor 19c via communication lines.

The external communication interface 11 includes an interface circuit which connects the first server 10 with the communication network 80. The first server 10 communicates with the self-driving vehicle 30 via the external communication interface 11.

The input device 12 includes devices necessary for the operator 12a to input the first driving instruction, for example, input devices such as a mouse and keyboard. The first server 10 may further include an output device such as a display. Furthermore, the first server 10 may be constituted by a plurality of computers.

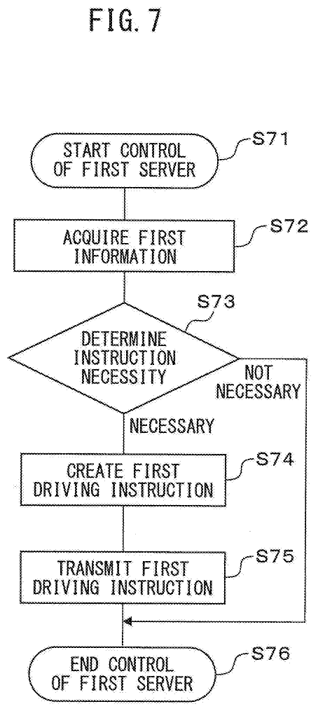

Regarding the structures of the storage device 13, the memory 19b, and the processor 19c, refer to the descriptions above regarding the self-driving vehicle 30. The details of the processes of the processor 19c will be described below regarding FIG. 7.

### (Second Server)

The second sever 20 is provided so as to be capable of communicating with the self-driving vehicle 30 via a gateway (not illustrated), the communication network 80, and the wireless communication base stations 81, 82. Furthermore, the second server 20 is provided so as to be capable of communicating with external sensors 45, 55 via a gateway (not illustrated), the communication network 80, the wireless communication base stations 81, 82, and wireless communication antennas 41a, 51a which are connected to the external sensors 45, 55. The second server 20 generates a second driving instruction instructing conditions related to driving control of the self-driving vehicle based on the second information received from the external sensors, and transmits the generated second driving instruction to the self-driving vehicle.

The external sensors 45, 55 are sensors which are different from the vehicle sensor 35 of the self-driving vehicle 30 itself, and acquire second information representing at least one of the status of the surroundings of the self-driving vehicle, the vehicle status of the self-driving vehicle itself, and the status of the interior of the self-driving vehicle. The external sensors may be, for example, at least one of the external sensor 45, which is attached to a vehicle 40 other than the target self-driving vehicle 30, and the external sensor 55, which is attached to a stationary object such as a utility pole, a guard rail, a building, a traffic light, or a column. The external sensors can include two or more sensors present in mutually different locations.

The second server 20 is used by service providers such as those described regarding the first server 10, organizations established by a plurality of service providers, operators or public institutions which manage specific areas, and operators or public institutions that manage roads, and is different from the first server 10.

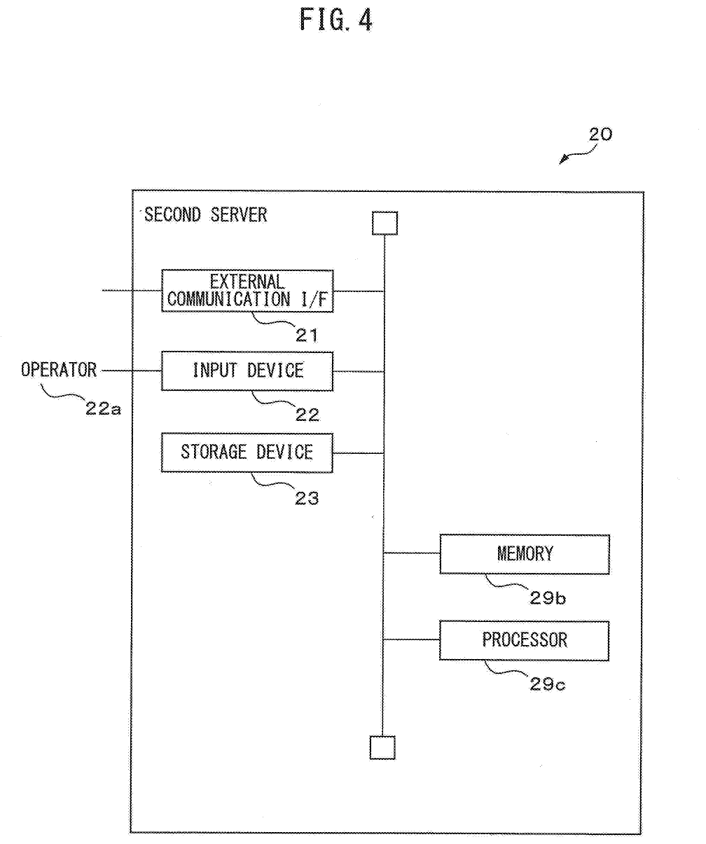

As shown in FIG. 4, the second server 20 comprises an external communication interface 21, an input device 22, a storage device 23, a memory 29b, and a processor 29c. The external communication interface 21, input device 22, storage device 23, and memory 29b are connected to the processor 29c via communication lines.

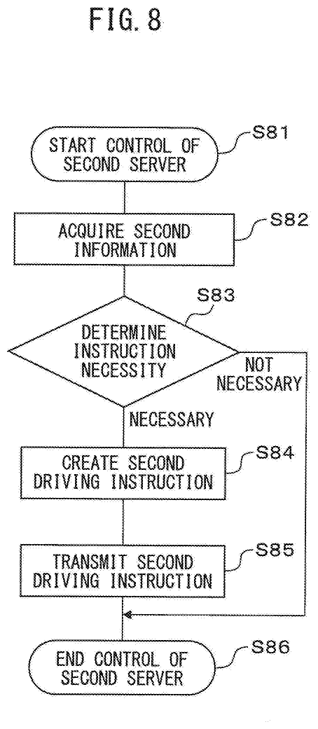

Regarding the structures of the external communication interface 21, the input device 22, the storage device 23, the memory 29b, and the processor 29c, refer to the above descriptions regarding the self-driving vehicle 30 and the first server 10. The details of the processes of the processor 39c will be described below regarding FIG. 8.

### (Mobility Service Series Flow)

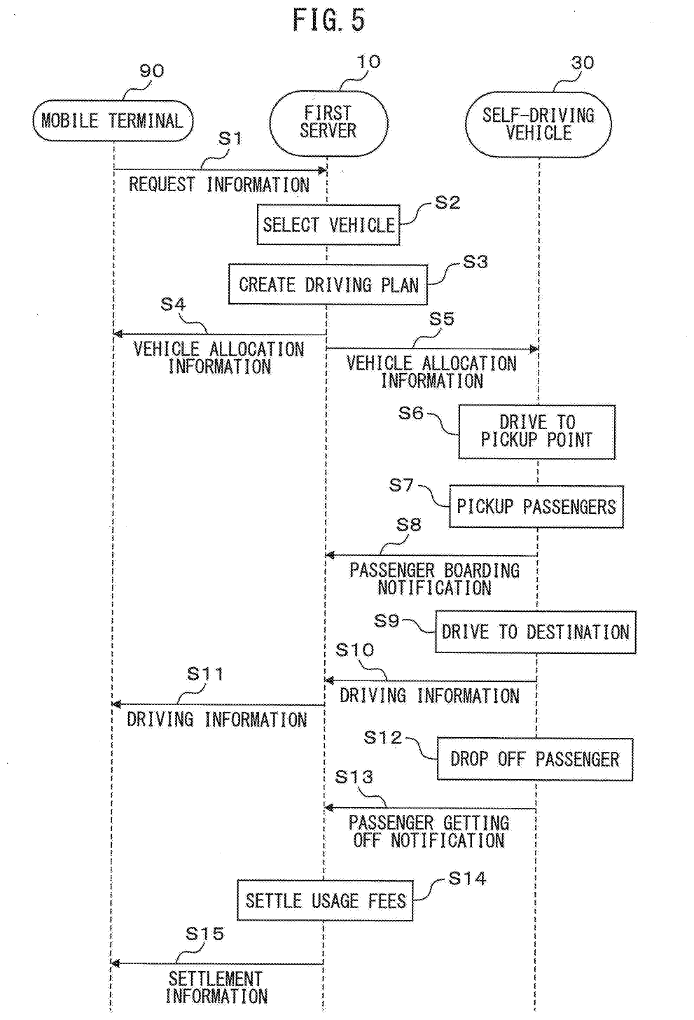

The series flow of the case in which the self-driving vehicle driving control system of the present disclosure is used for mobility services will be briefly described below with reference to FIG. 5.

FIG. 5 is a sequence diagram showing an example of the operation of the self-driving vehicle driving control system. In this sequence diagram, communication between the first server 10 and a mobile terminal 90, and communication between the first server 10 and the self-driving vehicle 30 is performed via the communication network 80.

The user which uses the mobility service registers user information in advance using the mobile terminal 90 or the like. Registered user information is stored in the storage device 13 of the first server 10 for each user. When the user requests usage of the mobility service, i.e., when a dispatch request is issued, the user operates the mobile terminal 90 to input request information on the mobile terminal 90. The input of request information is performed with, for example, a mobility service application installed on the mobile terminal 90.

When the request information is input on the mobile terminal 90, the mobile terminal 90 transmits the request information to the first server 10 (step S1). The request information includes the pickup point (e.g., the current location of the user), destination, user identification information (e.g., the user's registration number), passenger information (number of passengers, etc.), and availability of ride-sharing with other users. Note that the pickup point means the user's preferred boarding location.

When the first server 10 receives the request information from the user via the mobile terminal 90, a self-driving vehicle 30 suitable for transporting the user is selected (step S2). Specifically, the first server 10 performs matching of the user with a self-driving vehicle 30. The self-driving vehicle 30 suitable for transporting the user is, for example, the self-driving vehicle 30 waiting nearest to the pickup point. Note that in the case in which the user has allowed ride-sharing with other users, a self-driving vehicle 30 being used by other users may be selected.

Furthermore, the first server 10 creates a driving plan for transporting the user (step S3). The driving plan includes an estimated arrival time at the pickup point, a driving route to the destination, and an estimated arrival time at the destination.

Next, the first server 10 transmits the allocation information to the mobile terminal 90 (step S4). The allocation information transmitted to the mobile terminal 90 includes the estimated time of arrival at the pickup point, the driving route to the destination, the estimated time of arrival at the destination, identification information of the self-driving vehicle 30 (such as the license plate number, type of vehicle, color, etc.), the presence or absence of other ride-sharing users, etc. Furthermore, the server 10 transmits the allocation information to the self-driving vehicle 30 (step S5). The allocation information transmitted to the self-driving vehicle 30 includes the pickup point, the destination, the driving route to the destination, the identification information of the user, the number of passengers, etc.

When allocation information is received from the first server 10, the self-driving vehicle 30 begins to move to the pickup point (step S6). Thereafter, when arriving at the pickup point, the self-driving vehicle 30 picks up the passengers (the user or the user and other passengers) (step S7).

After the passengers have boarded, the self-driving vehicle 30 notifies the first server 10 that the passengers have boarded. Specifically, the self-driving vehicle 30 sends a boarding notification to the first server 10 (step S8). Furthermore, after the passengers have boarded, the self-driving vehicle 30 beings to move to the destination (step S9).

While moving to the destination, the self-driving vehicle 30 transmits driving information to the first server 10 at predetermined intervals (step S10). The driving information transmitted to the first server 10 includes the current location of the self-driving vehicle 30, and information regarding the surroundings of the self-driving vehicle 30. Furthermore, during the movement to the destination, the first server 10 transmits driving information to the mobile terminal 90 at predetermined intervals (step S11). The driving information transmitted to the mobile terminal 90 includes the current location of the self-driving vehicle 30, the estimated time of arrival at the destination, and information regarding traffic along the driving route.

Thereafter, when the self-driving vehicle 30 arrives at the destination, the passengers exit from the self-driving vehicle 30 (step S12). After the passengers have exited, the self-driving vehicle 30 notifies the first server 10 that the passengers have exited. Specifically, the self-driving vehicle 30 transmits an exit notification to the first server 10 (step S13).

Furthermore, after the passengers have exited, the first server 10 settles the usage fees for the mobility service (step S14). For example, the first server 10 settles the usage fees by account debit or credit card charge based on the user information stored in the storage device 13 of the first server 10. After the usage fees have been settled, the self-driving vehicle 30 transmits settlement information including settlement contents to the mobile terminal 90 (step S15).

### (Self-Driving Vehicle Driving Control System Control Flow)

As described above, in the instruction of conditions related to driving control based on information supplied from the self-driving vehicle, in some cases, the instruction of conditions related to driving control of the self-driving vehicle may be insufficient due to insufficiency of the information supplied from the self-driving vehicle.

In consideration of the foregoing, driving control of the self-driving vehicle may be performed based on information from the external sensors, which are different from the vehicle sensors of the self-driving vehicle itself, as in the self-driving vehicle driving control system of the present disclosure.

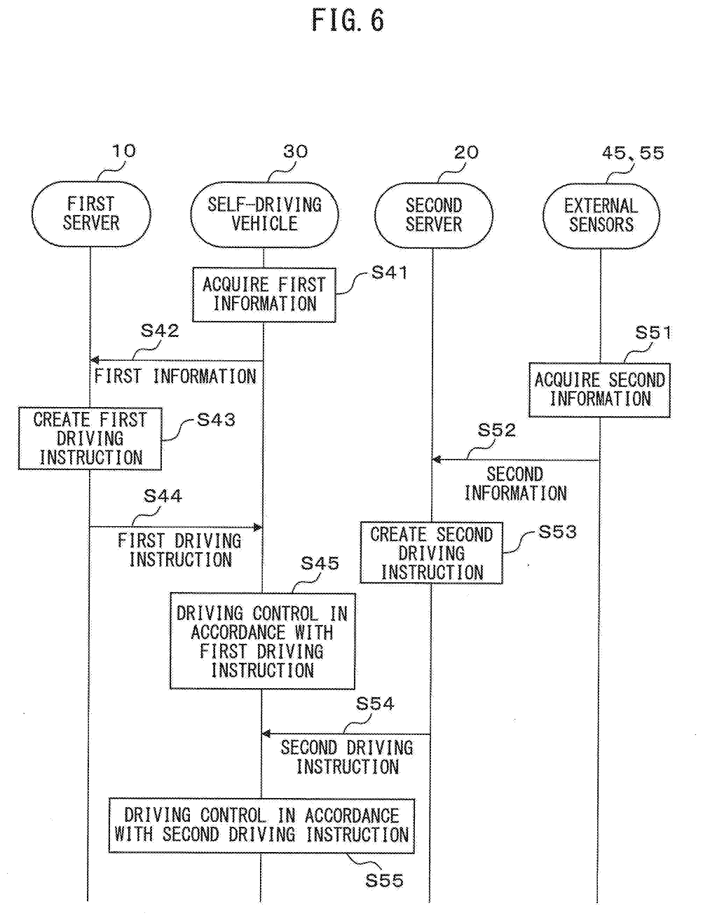

The control flow of the self-driving vehicle driving control system of the present disclosure will be described briefly below with reference to FIGS. 6 to 9. FIG. 6 is a sequence diagram showing an example of the operation of the self-driving vehicle driving control system of the present disclosure. In this sequence diagram, communication between the first server 10 and the self-driving vehicle 30, communication between the second server 20 and the self-driving vehicle 30, and communication between the second server 20 and the external sensors 45, 55 are carried out via the wireless communication base stations 81, 82 and the communication network 80.

The vehicle sensor mounted on the self-driving vehicle 30 acquires first information indicating at least one of the status of the surroundings of the self-driving vehicle, the vehicle status of the self-driving vehicle itself, and the status of the interior of the self-driving vehicle (step S41). Thereafter, the self-driving vehicle 30 transmits the first information to the first server via the wireless communication base stations and the communication network (step S42).

The first server 10, which has received the first information in this manner, generates the first driving instruction instructing conditions related to driving control of the self-driving vehicle based on the first information (step S43), and thereafter, transmits the generated first driving instruction to the self-driving vehicle (step S44). The generation of the first driving instruction can be performed automatically by the first server based on the first information or can be performed by a human operator via the input device of the first server.

The self-driving vehicle 30, which has received the transmitted first driving instruction in this manner, performs driving control in accordance with the first driving instruction (step S45).

It should be noted that when the generation of the first driving instruction is performed automatically by the first server, the flow shown in the flowchart of FIG. 7 may be used as the control routine of the first server. In other words, in this case, the processor begins control of the first server (step S71), the processor then receives the first information from the self-driving vehicle via the external communication interface (step S72), the processor determines the necessity to instruct conditions related to driving control of the self-driving vehicle (step S73), and when instruction is not necessary, ends control (step S76). Furthermore, when instruction is necessary, the processor generates the first driving instruction instructing the conditions related to driving control of the self-driving vehicle (step S74), the processor then transmits the generated first driving instruction to the self-driving vehicle via the external communication interface (step S75), and thereafter ends control (step S76).

Specifically, when the first information is image data related to the interior of the self-driving vehicle and the generation of driving instruction is automatically performed by the first server, it is identified from the image data by, for example, image recognition whether the status of the interior of the self-driving vehicle is normal or abnormal, and based thereon, when the status of the interior is abnormal, driving instruction for directing the vehicle to an appropriate destination can be generated. In connection thereto, for example, an abnormal state such as an ill passenger, a driving instruction for directing the vehicle to a suitable destination for medical treatment of the passenger, such as a hospital, can be generated. Note that for the image recognition described above, a pre-taught processor can be used, and specifically, a support vector machine, a multilayer perceptron, or the like can be used.

The first server transmits the generated first driving instruction to the self-driving vehicle, and the self-driving vehicle, which has received the first driving instruction, performs driving control in accordance with the first driving instruction. Specifically, when the first driving instruction is a driving instruction for directing the vehicle to a suitable location for medical treatment of a passenger, such as a hospital, the processor installed in the vehicle generates a new route, and drives the self-driving vehicle in accordance therewith. Furthermore, when the first driving instruction is a driving instruction for directing the vehicle to a suitable location for medical treatment of the passenger, such as a hospital, and the instruction includes a route therefor, the processor installed in the vehicle drives the self-driving vehicle in accordance therewith.

As shown in the sequence diagram of FIG. 6, the external sensors 44, 45, which are different from the vehicle sensor, acquire second information representing at least one of the status of the surroundings of the self-driving vehicle, the vehicle status of the self-driving vehicle itself, and the status of the interior of the self-driving vehicle (step S51). Thereafter, the external sensors 44, 45 transmit the second information to the second server via the wireless communication base stations and the communication network (step S52).

The second server 20, which has received the second information in this manner, generates the second driving instruction indicating conditions related to driving control of the self-driving vehicle based on the second information (step S53), and thereafter transmits the second driving instruction to the self-driving vehicle (step S54). The generation of the second driving instruction can be performed automatically by the second server based on the second information, or can be performed by a human operator via the input device of the second server.

The self-driving vehicle 30, which has received the transmitted second driving instruction in this manner, performs driving control in accordance with the second driving instruction (step S55).

Note that when the generation of the second driving instruction is performed automatically by the second server, the flow shown in the flowchart of FIG. 8 may be used as the control routine of the second server. In other words, in this case, the processor begins control of the second server (step S81), the processor then receives the second information from the external sensor via the external communication network (step S82), the processor determines the necessity to instruction conditions related to driving control of the self-driving vehicle (step S83), and when instruction is not necessary, ends control (step S86). Furthermore, when instruction is necessary, the processor generates the second driving instruction indicating conditions related to driving control of the self-driving vehicle (step S84), the processor then transmits the generated second driving instruction to the self-driving vehicle via the external communication interface (step S85), and thereafter, ends control (step S86).

In order to, for example, specify the target self-driving vehicle, the second server detects the vehicle and the area of the vehicle in which the license plate is attached from the image data obtained by the external sensors. By executing character recognition processing on such area in which the license plate is attached, the license plate of the vehicle can be identified as the identification information. It should be noted that, for example, template matching can be used as the character recognition processing, or alternatively, a pre-taught character recognition identification device can be used.

Specifically, when the second information is image data of the appearance of the self-driving vehicle and the generation of the driving instruction is performed automatically by the second server, it is identified from the image data by, for example, image recognition whether the appearance of the self-driving vehicle is normal or abnormal, and based thereon, when the status of the appearance is abnormal such as the case in which the vehicle is damaged, the vehicle can be stopped in a safe location, and a driving instruction for releasing the door locks can be generated. A pre-taught processor as described above can be used for such image recognition.

When, for example, the second information is image data related to the area in which the self-driving vehicle is going to drive and the generation of the driving instruction is performed automatically by the second server, it is identified, from the image data by image recognition, whether the area in which the self-driving vehicle is going to drive is normal or abnormal, and based thereon, when the area is abnormal, such as in a state in which a traffic accident or rioting has occurred, a driving instruction for driving the vehicle so as to avoid such an area can be generated. Furthermore, when, for example, a fire has occurred in the vicinity of the path along which the self-driving vehicle is going to drive, and thus the gathering of emergency vehicles in such an area is expected, a driving instruction for driving the vehicle so as to avoid such an area can be generated. A pre-taught processor as described above can be used for such image recognition.

The second server transmits the generated second driving instruction to the self-driving vehicle, and the self-driving vehicle, which has received the second driving instruction, performs driving control in accordance with the second driving instruction. Thus, when the second driving instruction instructs to stop the vehicle in a safe location and release the door locks, the processor installed in the vehicle searches for a location in which the vehicle can be safely stopped based on the information of the vehicle sensors mounted on the vehicle, and stops the vehicle in that location.

When the self-driving vehicle receives both the first and second driving instructions, i.e., when, for example, the self-driving vehicles receives the second driving instruction from the second server during the period in which the first driving instruction from the first server is valid, or vice versa, either the first driving instruction or the second driving instruction may be prioritized. Specifically, in these cases, it can be determined in advance which of the first driving instruction and the second driving instruction will be prioritized, and the priority can be stored in the storage of the self-driving vehicle. In other words, either the first driving instruction or the second driving instruction can be prioritized by storing a table describing the relationship between the IDs of the first server and the second server and their priority levels in the storage device, and including the ID of the server which created a driving instruction along therewith. Furthermore, in these cases, it is possible to determine in advance which of the driving instruction received earlier and the driving instruction received later is to be prioritized, and store the determination in the storage of the self-driving vehicle.

In these cases, the second driving instruction may be prioritized over these first driving instruction. This is because the second information, which is received by the second server from the external sensors, may objectively represent the status of the self-driving vehicle as compared to the first information, which is received from the self-driving vehicle.

However, it is possible that the second information received by the second server from the external sensors may not be suitable for the specific operation of the self-driving vehicle, in particular, the specific operation of the self-driving vehicle input by the operator via the input device of the server. Thus, the type of conditions related to driving control which can be instructed in accordance with the second driving instruction generated by the second server may be more limited than the types of conditions related to driving control which can be instructed in accordance with the first driving instruction created by the first server. Specifically, the conditions related to driving control which can be instructed in accordance with the second driving instruction may, for example, not include continuous driving of the vehicle, but may be limited to stopping operations of the vehicle such as emergency stops.

According to the system of the present disclosure, the first server can generate the first driving instruction based on the first information received from the vehicle sensor and can transmit the generated first driving instruction to the self-driving vehicle, the second server can generate the second driving instruction based on the second information received from the external sensors and can transmit the generated second driving instruction to the self-driving vehicle. Thus, since the first server and the second server can generate the driving instructions based on different information and can transmit the generated driving instructions to the self-driving vehicle, the first server and the second server can serve as redundant safety devices.

It should be noted that in addition to the second information from the external sensors, the second server can receive the first information from the self-driving vehicle. Likewise, in addition to the first information from the self-driving vehicle, the first server can receive the second information from the external sensors. Thus, the information regarding the self-driving vehicle received by the second server may be the same as or different from the information regarding the self-driving vehicle received by the first server.

When both the first and second servers receive the first information from the self-driving vehicle and the second information from the external sensors, the first server performs calculation so as to maximize the influence of the first information and the second server performs calculation so as to maximize the influence of the second information, whereby the first and second servers can serve as redundant safety devices.

FIG. 9 is a flowchart showing an exemplary control routine of the self-driving vehicle when the second driving instruction from the second server is prioritized over the first driving instruction from the first server.

In other words, in the method for controlling the self-driving vehicle, the processor starts the self-driving vehicle control method (step S91), the processor confirms the presence or absence of the second driving instruction from the second server (step S92), in the case in which the second driving instruction is present, the processor performs driving control in accordance with the second driving instruction (step S93), and thereafter, ends control (step S94). Furthermore, when the second driving instruction is not present, the processor confirms the presence or absence of the first driving instruction (step S95), in the case in which the first driving instruction in present, the processor performs driving control in accordance with the first driving instruction (step S96), and thereafter, end control (step S94). Furthermore, in the case in which neither the first driving instruction nor the second driving instruction are present, the processor ends control (step S94).

### REFERENCE SIGNS LIST

10 first server
20 second server
30 self-driving vehicle
31a, 41a, 51a wireless communication antenna
35 vehicle sensor
40 vehicle
45, 55 external sensor
50 stationary object
80 communication network
81, 812 wireless communication base station

1. A self-driving vehicle driving control system, comprising:
a self-driving vehicle which is capable of autonomous driving, and which includes a vehicle sensor which acquires first information representing at least one of a status of surroundings of the self-driving vehicle, a vehicle status of the self-driving vehicle itself, and a vehicle interior status of the self-driving vehicle,
a first server which is provided so as to be capable of communicating with the self-driving vehicle, which generates a first driving instruction for instruction of conditions related to driving control of the self-driving vehicle based on the first information received from the self-driving vehicle, and which transmits the generated first driving instruction to the self-driving vehicle, and
a second server which is provided so as to be capable of communicating with the self-driving vehicle, the second server being provided so as to be capable of communicating with an external sensor different from the vehicle sensor and which acquires second information representing at least one of the status of the surroundings of the self-driving vehicle, the vehicle status of the self-driving vehicle itself, and the vehicle interior status of the self-driving vehicle, the second server generating a second driving instruction for instruction of conditions related to driving control of the self-driving vehicle based on the second information received from the external sensor, and transmitting the generated second driving instruction to the self-driving vehicle, wherein
driving of the self-driving vehicle is controlled in accordance with the first or second driving instruction.

2. The system according to claim 1, wherein the self-driving vehicle prioritizes the second driving instruction when the self-driving vehicle receives both the first and second driving instructions.

3. The system according to claim 1, wherein a type of conditions related to the driving control which can be instructed by the second driving instruction is more limited than the type of conditions related to driving control which can be instructed by the first driving instruction.

4. The system according to claim 1, wherein the second server generates the second driving instruction based on the first information received from the self-driving vehicle in addition to the second information received from the external sensor.

5. The system according to claim 1, wherein the external sensor is at least one of a sensor attached to a vehicle other than the self-driving vehicle and a sensor attached to a stationary object.

6. The system according to claim 1, wherein the external sensor comprises two or more sensors present in positions different from each other.

7. A self-driving vehicle which is capable of autonomous driving, comprising:
a vehicle sensor which acquires first information representing at least one of a status of surroundings of the self-driving vehicle, a vehicle status of the self-driving vehicle itself, and a vehicle interior status of the self-driving vehicle,
an external communication interface which is configured so as to be capable of communicating with a first server and a second server, wherein the external communication interface receives, from the first server, a first driving instruction for instruction of conditions related to driving control of the self-driving vehicle generated based on the first information, and receives, from the second server, a second driving instruction for instruction of conditions related to driving control of the self-driving vehicle generated based on second information received from an external sensor different from the vehicle sensor and which acquires the second information indicating at least one of a status of the surroundings of the self-driving vehicle, the vehicle status of the self-driving vehicle itself, and the vehicle interior status of the self-driving vehicle, and
a processor which controls driving of the self-driving vehicle in accordance with the first or second driving instruction.

8. The self-driving vehicle according to claim 7, wherein the processor prioritizes the second driving instruction when the external communication interface receives both the first and second driving instructions.
